(19) United States
(12) Patent Application Publication
(10) Pub. No.: US 2014/0248560 A1
(43) Pub. Date: Sep. 4, 2014

(54) PROCESS FOR PREPARING A PARTICULATE SOLID AND A PARTICULATE SOLID

(71) Applicants: Martin Edwards, Manchester (GB); Daniel Morris, Manchester (GB); Miguel Rodriguez-Vazquez, Manchester (GB)

(72) Inventors: Martin Edwards, Manchester (GB); Daniel Morris, Manchester (GB); Miguel Rodriguez-Vazquez, Manchester (GB)

(73) Assignee: FUJIFILM IMAGING COLORANTS LIMITED, Manchester (GB)

(21) Appl. No.: 14/343,401

(22) PCT Filed: Sep. 25, 2012
(86) PCT No.: PCT/GB2012/052360

§ 371 Date: Mar. 7, 2014

(30) Foreign Application Priority Data
Sep. 28, 2011 (GB) 1116665.9
May 21, 2012 (GB) 1208912.4

(51) Int. Cl. G03G 9/08

(52) U.S. Cl. CPC G03G 9/0819
USPC 430/137.14

(57) ABSTRACT

A process for preparing a particulate solid is described, which comprises the steps of a) aggregating a dispersion comprising the particles i) and ii) and a liquid medium, wherein i) is 25 to 50 parts by weight of non-polymeric particles having an average particle size of from 1 to 10 microns and having a density of no more than 4 g/cm³; and ii) is 50 to 75 parts by weight of polymer particles having an average particle size of from 50 to 150 nm; b) optionally stabilising the aggregated particles; and c) heating the aggregated particles so as to cause particle coalescence.

### FIELD OF THE INVENTION

This invention relates to a process for preparing a particulate solid and to particulate solids prepared by said process. The particulate solids can contain many different kinds of non-polymeric materials dispersed within a coalesced polymer matrix. Such particulate solids can be used in inks, paints, thermoplastics, thermosets and especially as toners for electrophotographic photocopiers and printers.

### BACKGROUND OF THE INVENTION

Many applications require coalesced particulate solid particles comprising polymeric and non-polymeric materials. Electrophotographic toner particles, for example, typically comprise a polymeric material along with non-polymeric materials such as pigments (for colouration) and/or charge control agents (for controlling triboelectric charging properties).

Emulsion aggregation (sometimes emulsion association) is a known process used to provide particulate solids (e.g. toner particles). In this process a dispersion of polymer particles along with other non-polymeric particles are aggregated together to form aggregated particles (clusters of particles), the aggregated particles are sometimes grown and/or stabilised and then they are generally heated to coalesce the polymer material in each aggregated particle so forming the final particulate solid. Without the heating step the resulting particles would be far too friable or fragile for use in most applications.

An example of the emulsion aggregation technology is disclosed in PCT patent publication WO1998/50828.

For some applications we considered that it would be highly desirable to provide toners with very high loadings of pigments and/or charge control agent. This could facilitate, for example, the provision of intensely vivid prints and/or extremely robust triboelectric charge control.

In our studies we found it extremely difficult to prepare toner particles using the emulsion aggregation approach with high weight-based loadings of non-polymeric particles and relatively smaller loadings of polymer particles. Our studies showed that the difficulty is even more pronounced for low density non-polymeric particles. We found that it is reasonably straightforward to prepare toner particles containing e.g. 25% by weight of magnetite (which is very dense) using the emulsion aggregation route. In stark contrast, early attempts at preparing equivalent toners using high weight loadings of pigment particles (which is much less dense) proved unsuccessful. In particular, we noted that the heating step seemed not to result in sufficiently coalesced (fused) particles. Instead, the particles prepared with high loadings of low density non-polymeric particles remained highly irregular in shape and mechanically fragile or easily prone to break-up. Such particles were entirely unsuitable for formulation into functioning toners.

After extensive studies we found that only by careful control of several parameters simultaneously could coalesced toners containing high relative loadings of low density non-polymeric particles be prepared by emulsion aggregation technology.

In particular, we found that the particle size of the non-polymeric particles should be much larger than the conventional size and the particle size of the polymer particles should be within a narrow range. When all these steps are taken we found that the resulting aggregated particles could be coalesced successfully resulting in mechanically robust particles well suited to use in electrophotographic printing.

### FIGURE

FIGS. 1 to 4—show the mean circularity of particles as a function of the coalescence time.

In each Figure the diamonds and triangles represent data points. The Y-axis is the average circularity as measured by a Sysmex FPIA-3000 device sold by Malvern. The X-axis is the coalescence time in minutes, that is to say the time after reaching the coalescence temperature.

### First Aspect

According to a first aspect of the present invention there is provided a process for preparing a particulate solid comprising the steps:
a) aggregating a dispersion comprising the particles i), ii) and a liquid medium:
   i) 25 to 50 parts by weight of non-polymeric particles having an average particle size of from 1 to 10 microns and having a density of no more than 4 g/cm³;
   ii) 50 to 75 parts by weight of polymer particles having an average particle size of from 50 to 150 nm;
b) optionally stabilising the aggregated particles;
c) heating the aggregated particles so as to cause particle coalescence.

### DEFINITIONS

As used herein the words such as “a” and “an” are meant to include the possibility of having more than one of that item.

### Liquid Medium

The liquid medium preferably is or comprises water (is aqueous). The dispersion preferably has a pH of 5 or more, more preferably 7 or more prior to aggregation. Such a pH is especially suited to particles which are stabilised by carboxylic acid groups bonded to their surface and/or by dispersants having carboxylic acid groups. When other liquids are present in the liquid medium these may be organic liquids, more preferably water miscible organic liquids. Preferably the liquid medium comprises at least 95%, more preferably at least 99% by weight of water relative to all the liquid components in the liquid medium. More preferably, the only liquid component present in the liquid medium is water.

### Polymer Particles

As used herein the term polymer preferably means those materials having a molecular weight of 1,000 or more. As used herein the terms polymeric and polymer are meant to have exactly the same meaning.

Preferably, the molecular weight is established by gel permeation chromatography. Preferably, the molecular weight is a weight averaged molecular weight. Preferably, the gel permeation method establishes the molecular weight by reference to polystyrene standards. Polymers are obtained by polymerising one or more monomers.

Preferably, the polymer in the polymer particles has a molecular weight of from 1,000 to 1,000,000; more preferably from 1,000 to 500,000, especially from 1,000 to 100,000; and most especially from 1,000 to 50,000.

Preferably, the polymer is substantially linear. Preferably, the polymer is substantially free of branches and cross-linked sites.

Suitable polymer materials for the polymer particles include those prepared by polymerising ethylenically unsaturated monomers of these polyvinyl, poly(meth)acrylates and polyvinyl-co-(meth)acrylates are preferred.

Preferred polymer materials prepared by polymerising ethylenically unsaturated monomers are those obtained by copolymerising monomers selected from (meth)acrylates, styrenics, (meth)acrylamides, acrylonitrile, butadiene, chloroprene, isoprene including mixtures thereof. Especially preferred monomers are selected from alkyl (meth)acrylates, ionic functional acrylates, hydroxyl (—OH) functional acrylates and optionally styrene. Of the ionic functional acrylates anionic and especially carboxylic acid groups are preferred.

Especially preferred polymer materials are those prepared by polymerising a mixture of C₁₋₁₂alkyl (meth)acrylate, hydroxyl (—OH) functional (meth)acrylate and optionally styrene.

Preferred C₁₋₁₂alkyl groups are methyl, ethyl, butyl, hexyl, octyl and decyl which may be linear or branched.

In some cases, we have found that better coalescence rates occur with a lower styrene content. Hence we have found that polymers containing less than 40 wt %, more preferably less than 30 wt %, even more preferably less than 15 wt %, especially less than 5 wt % and most especially 0 wt % of styrenic repeat units tend to coalescence more readily.

Where especially easy particle coalescence is desired we have found that it is desirable that the polymer material in the polymer particles is obtained from copolymerising a monomer mixture comprising methyl methacrylate. Accordingly, the polymer preferably comprises the repeat units from methyl methacrylate. Preferably such repeat units are present in the polymer in more than 10 wt %, more preferably more than 25 wt %, especially more than 40 wt %, more especially more than 50 wt % and particularly especially more than 60 wt %. In some cases the amount of methyl methacrylate repeat units in the polymer is at least 70 wt % by weight. Preferably, the amount of methyl methacrylate repeat units in the polymer is less than 99 wt %, more preferably less than 95 wt %, even more preferably less than 90 wt % and especially less than 85 wt %. The remaining weight percent of other monomer units required to reach 100 wt % may be from any other monomer. Preferably, the remaining monomer repeat units other than those from methyl methacrylate are those from C₂₋₁₀ alkyl (meth)acrylates (especially butyl) and 2-hydroxy ethyl methacrylate.

Preferred hydroxyl (—OH) functional (meth)acrylates are hydroxybutyl, hydroxypropyl and especially hydroxyethyl (meth) acrylates.

Other suitable polymer materials include, polyesters, polycarbonates, polyurethanes and waxes. Of these polyester are especially suitable.

Suitable polyesters are typically made from at least one (preferably one or two) polyfunctional (e.g. difunctional, trifunctional and higher polyfunctional) acid, ester or anhydride and at least one (preferably one or two) polyfunctional (e.g. difunctional, trifunctional and higher polyfunctional) alcohol. More specifically, polyesters may be made from at least one polyfunctional carboxylic acid, ester or anhydride and at least one polyfunctional alcohol. Methods and reaction conditions for the preparation of polyester resins are well known in the art. Melt polymerisation and solution polymerisation processes may be used to prepare polyesters. The polyfunctional acid or ester or anhydride component(s) may be employed in an amount which is 45-55% by weight of the total polyester resin and the polyfunctional alcohol component(s) may be employed in an amount which is 45-55% by weight of the total polyester resin. Preferably, the aforementioned components to make the polyester resin are employed in amounts such that acid groups remain in the polyester resin.

Examples of suitable difunctional acids include: acids such as di-carboxylic acids including: aromatic dicarboxylic acids such as: phthalic acid; isophthalic acid; terephthalic acid; aliphatic di-carboxylic acids such as: unsaturated di-carboxylic acids, including maleic acid, fumaric acid, citraconic acid, itaconic acid, saturated di-carboxylic acids, including malonic acid; succinic acid; glutaric acid; adipic acid; pimelic acid; azelaic acid; sebacic acid; 1,2-cyclohexanedioic acid; 1,3-cyclohexanedioic acid; 1,4-cyclohexanedioic acid; succinic anhydride; glutaric anhydride; substituted (especially alkyl substituted, more especially methyl substituted) forms of the foregoing compounds; and mixtures of two or more of the foregoing compounds. Examples of suitable difunctional esters include esters of the foregoing difunctional acids and anhydrides, especially alkyl esters and more especially methyl esters thereof. Other examples of suitable difunctional anhydrides include anhydrides of the foregoing difunctional acids.

Preferably, the polyester is made from at least one aromatic dicarboxylic acid or ester, especially isophthalic acid and/or terephthalic acid and/or ester thereof.

Examples of suitable trifunctional or higher functional acids, esters or anhydrides include: trimellitic acid, pyromellitic acid and the like and esters and anhydrides thereof.

Examples of suitable difunctional alcohols include: aliphatic diols such as: alkylene glycols including ethylene glycol, 1,2-propylene glycol, 1,3-propylene glycol, 1,2-butylene glycol, 1,3-butylene glycol, 1,4-butylene glycol, 1,2-pentylene glycol, 1,3-pentylene glycol, 1,4-pentylene glycol, 1,5-pentylene glycol, 1,2-hexylene glycol, 1,3-hexylene glycol, 1,4-hexylene glycol, 1,5-hexylene glycol, 1,6-hexylene glycol, heptylene glycols, octylene glycols, decylene glycol, dodecylene glycol; 2,2-dimethyl propane diol; 1,2-cyclohexane diol; 1,3-cyclohexane diol; 1,4-cyclohexane diol; 1,2-cyclohexane dimethanol, 2-propene-diol; aromatic diols such as bisphenol A derivatives, especially alkoxylated bisphenol A derivatives, including bisphenol A alkoxylated with ethylene oxide and/or propylene oxide, e.g. ethoxylated bisphenol A compounds and propoxylated bisphenol A compounds; substituted (especially alkyl substituted, more especially methyl substituted) forms of the foregoing compounds and mixtures of two or more of the foregoing compounds.

Preferably, the polyester is made from at least one aliphatic diol and optionally at least one aromatic diol. In some embodiments, the polyester is made from at least one aliphatic diol and at least one aromatic diol. Preferred aliphatic diols are ethylene glycol, 1,3-propylene glycol and 2,2-dimethyl propane diol. Preferred aromatic diols are bisphenol A derivatives, especially ethoxylated bisphenol A and propoxylated bisphenol A.

Examples of suitable trifunctional or higher functional alcohols include trimethylolpropane, pentaerythritol and sorbitol and the like.

The polymer material can be a physical blend of the above polymer materials or a graft of two or more the above polymer materials. Especially preferred copolymers are those comprising both vinyl and (meth)acrylate monomer repeat units.

The majority of waxes are polymeric in nature and such waxes if used would be present in component ii), provided they met the required sizes.

The relative softness of most waxes and the tendency for waxes to sometimes contaminate the surfaces of the components in electrophotographic printers means that it is sometimes preferred not to incorporate too much wax into the toner. Preferably, the polymer particles comprise less than 15%, especially less than 10% by weight of (polymeric) wax. In some cases, for example where the printer fusion rollers use a release oil, it is desirable that the polymer particles comprise no wax. Where more than one type of polymer particles are used it is preferred that there is less than 10% by weight, more preferably less than 5%, especially less than 2% and more especially less than 1% by weight of (polymeric) wax relative to all the polymer present in all the polymer particles. In one case all the polymer particles present in the liquid dispersion contain no wax. Suitable polymeric waxes include polyethylene, polypropylene, paraffin, Fischer-Tropsch and carnauba waxes. In many cases, it is preferred that polymer particles contain no polymeric wax.

The particulate form of the polymer may be made by solution dispersion or more preferably emulsion polymerisation. Preferably, the polymer particles are substantially spherical in shape.

Preferably, the particle size of the polymer particles is established by light scattering, more preferably by laser light diffraction. A suitable device is the Matersizer™ 2000 device from Malvern. Preferably, the particle size of the polymer particles refers to the average diameter of the particles. Preferably, the particle size of the polymer particles is a D₅₀ volume-averaged particle size. Preferably, the average particle size of the polymer particles is from 70 to 150 nm, more preferably from 70 to 140, even more preferably from 80, to 140 nm, especially from 85 to 140 nm and even more especially from 90 to 140 nm.

### Non-Polymeric Particles

As used herein the terms non-polymeric and non-polymer are meant to have exactly the same meaning.

As used herein the term non-polymeric preferably means those materials having a molecular weight of less than 1,000. Preferably, the molecular weight is from 50 to 999, more preferably from 100 to 999. The preferred methods for establishing the molecular weight of the material in the non-polymeric particles are as mentioned above for polymeric materials. Of course, non-polymeric materials are not polymers (i.e they are not materials obtained from the polymerisation of one or more monomers).

Any suitable non-polymeric material may be used. Crystalline organic compounds and metal complexes are especially suitable. The preferred non-polymeric particles are selected from pigments and charge control agents.

Preferably, the non-polymeric particles have a density of no more than 3 g/cm³, especially no more than 2 g/cm³. Preferably, the non-polymeric particles have a density of at least 0.5 g/cm³. Preferably, the density of the non-polymeric particles is from 0.7 to 2 g/cm³, even more preferably from 1 to 2 g/cm³.

Whilst not being limited by any particular theory it is speculated that the reason why particle coalescence is more difficult with relatively high weight loadings of lower density non-polymeric materials is because the volume fraction of infusible non-polymeric material is much higher for lower density materials. Magnetite for example because of its very high density can be present in very high weight percentage loadings whilst still being present at relatively low volume fractions. The same is not at all true for low density non-polymeric materials where the weight and volume fractions are often fairly similar.

Preferably, the particle size of the non-polymeric particles is established by light scattering, more preferably by a laser light diffraction device. A suitable device is the Mastersizer™ 2000 device from Malvern. Preferably, the particle size of the non-polymeric particles refers to the average diameter of the particles. Where the particles are not spherical the diameter is an effective diameter (or conceptual) diameter rather than a real one. Preferably, the particle size of the non-polymeric particles is a D₅₀ volume-averaged particle size. Preferably, the average particle size of the non-polymeric particles is from 1 to 7 microns, more preferably 1 to 5 microns, especially from 2 to 5 microns, more especially from 1.2 to 5 microns, even more especially from 1.5 to 4.5 microns and most especially from 2 to 4 microns.

In some cases it is preferred that the average particle size of the non-polymeric particles is at least 1.2, more preferably at least 1.5, especially at least 1.7 and more especially at least 2 microns. The average particle size can be no more than 10 microns (according to the present invention) but it is preferably no more than 8 microns, more preferably no more than 7 microns, especially no more than 6 microns and more especially no more than 5 microns.

The non-polymeric material in the non-polymeric particles may be soluble in the polymer material forming the polymer particles. More preferably, however, the non-polymeric material is substantially insoluble in the polymer material. Preferably, each particle of the final particulate solid comprises a dispersion of the non-polymeric particles in a matrix of coalesced polymer particles.

Just a few waxes are non-polymeric in nature. Such waxes would, if used, be present as component i), if the particles met the required sizes as indicated in the first aspect of the present invention.

As mentioned above it is often preferred that the final particles comprise only small amounts of wax. Accordingly, it is preferred that the non-polymeric particles comprise less than 5 parts, more preferably less than 2 parts, especially less than 1 part and most especially 0 parts by weight of non-polymeric wax.

### Pigments

As mentioned above the non-polymeric material can be a pigment.

The pigment may be organic or inorganic. Examples of organic pigments are those from the azo (including disazo and condensed azo), thioindigo, indanthrone, isoindanthrone, anthanthrone, anthraquinone, isodibenzanthrone, triphendioxazine, quinacridone and phthalocyanine series, especially copper phthalocyanine and its nuclear halogenated derivatives, and also lakes of acid, basic and mordant dyes. Preferred organic pigments are phthalocyanines, especially copper phthalocyanine pigments, azo pigments, indanthrones, anthanthrones and quinacridones.

The preferred inorganic pigment is carbon black.

All the above pigments have densities well under the 4 g/cm³ requirement.

It is preferred that the dispersion prior to aggregation comprises no particles having a density of greater than 4 g/cm³, even more preferably no particles having a density of greater than 2 g/cm³. This means that the dispersion (and the resulting particulate solid) will preferably contain no dense pigments such as for example magnetite (density>5 g/cm³).

The density of the non-polymeric material is often known in the literature or in supplier information. The density value used is a true not an apparent or bulk density. One method for obtaining the density is by obtaining the volume of a sample by pycnometry, especially helium gas pycnometry and then dividing the weight by the volume.

The density can also be obtain by using ASTM D153-84(2008) to obtain the specific gravity of the pigment and then multiplying this value by the density of water at the appropriate temperature. Where more precision is required test method B of the above ASTM is preferred.

### Charge Control Agents

As mentioned above the non-polymeric material can be a charge control agent. Suitable charge control agents may be selected from metal azo complexes, phenolic polymers, calixarenes, nigrosine, quaternary ammonium salts, arylsulphones and especially metal salts of organic carboxylic acid. Preferred metal salts of organic carboxylic acids include the carboxyl functional aromatic compounds optionally having hydroxyl groups complexed with metal ions. Especially suitable metal ions for complexation are aluminium and zinc.

### Particle Stabilisation

The particles in the liquid dispersion may be stabilised colloidally by schemes i) and/or ii):
i) having stabilising groups covalently bonded to the particle itself; and/or
ii) a dispersant having stabilising groups which is adsorbed onto the surface of the particles.

Of the two schemes i) and ii) we have found that:

For polymer particles where the polymer is prepared by polymerising ethylenically unsaturated monomers and also for non-polymeric particles generally scheme ii) is more effective.

For polymer particles where the polymer is a polyester or polyurethane scheme i) is more effective.

Of course, it is possible to use both schemes for any kind of particle.

The stabilising groups are preferably hydrophilic and may be non-ionic or more preferably ionic.

Preferred ionic stabilising groups are cationic and especially anionic groups. Of the anionic groups sulfonic acid, phosphonic acid and especially carboxylic acid groups are preferred. Preferred non-ionic stabilising groups are hydroxyl (—OH) and polyethyleneoxy groups.

Especially when the aggregation is by means of changing the pH of the dispersion it is preferred that the stabilising groups can be reversibly converted from an ionic form to a non-ionic form.

Preferably, the polymer and the non-polymeric particles are stabilised by groups which are reversibly convertible from an ionic to a non-ionic form by means of adjusting the pH.

In one case, a dispersant has stabilising groups which can be reversibly converted from an ionic form to a non-ionic form and is adsorbed onto the surface of the particles.

In another case the particles have stabilising groups which are covalently bonded to the particle which can be reversibly converted from an ionic form to a non-ionic form.

Especially preferably the stabilising groups which can be reversibly converted from an ionic form to a non-ionic form are carboxylic acid groups or salts thereof. The ionic form is the CO₂⁻ (salt form) the non-ionic form is the CO₂H (acid form). For carboxylic acids the salt form tends to predominate above pH 5 whilst the acid form predominates below pH 5.

It is possible to stabilise either the polymer solid particles or the non-polymeric particles in this way. More preferably both polymer and non-polymeric particles are stabilised as preferred above.

Suitable dispersants for stabilising the polymer or non-polymeric particles include fatty acid carboxylates, including alkyl carboxylates; and alkyl or aryl alkoxylated carboxylates, which include, for example, alkyl ethoxylated carboxylates, alkyl propoxylated carboxylates and alkyl ethoxylated/propoxylated carboxylates. Examples of suitable cationic dispersants are: quaternary ammonium salts; benzalkonium chloride; ethoxylated amines.

Preferred dispersants having carboxylic acid groups including fatty acid carboxylates, alkyl carboxylates and especially alkyl or aryl alkoxylated carboxylates. Examples of fatty acid carboxylates include salts of lauric acid, myristic acid, palmitic acid, stearic acid, oleic acid and the like.

Most preferred of all dispersants are the alkyl alkoxylated carboxylates, such as, e.g., alkyl ethoxylated carboxylates, alkyl propoxylated carboxylates and alkyl ethoxylated/propoxylated carboxylates, especially wherein the alkyl is C₈₋₁₄ alkyl. Suitable alkyl alkoxylated carboxylates are commercially available, such as in the Akypo™ range of surfactants from Kao Corporation and the Marlowet™ range of surfactants from Sasol.

Preferred dispersants are alkyl or aryl alkoxylated carboxylates represented by Formula A below:

R^{a}—O—(Z)ₘ—CH₂—CO₂H Formula A

wherein:
R^{a} represents an optionally substituted alkyl or aryl group;
Z represents an alkylene oxide group;
m is an integer from 1 to 20; and
   which may be in the acid (protonated form as shown in Formula A) or in the form of a salt.

Preferably, in Formula A, R^{a} represents an optionally substituted alkyl group. The optionally substituted alkyl group is preferably a C₁₋₂₀ alkyl group, more preferably a C₄₋₁₈ alkyl group, still more preferably a C₆₋₁₆ alkyl group and most preferably a C₈₋₁₄ alkyl group. Preferably the R^{a} alkyl group is unsubstituted.

Preferably, Z represents an ethylene oxide (EO) or propylene oxide (PO) group. Each Z (where m is greater than 1) may be the same alkylene oxide group, e.g. each Z may be EO or each Z may be PO. Alternatively, each Z may independently represent, different alkylene oxide groups, such as EO or PO, such that the different alkylene oxide units (e.g. EO and PO units) may be randomly positioned in the —(Z)ₘ— chain.

Preferably, m is an integer from 2-16, more preferably from 3-12 and most preferably from 4-10.

Preferably, the salt form is that of an alkali metal or an ammonium salt. Salts with lithium, sodium, potassium and ammonium are preferred.

When polymer particles are stabilised by scheme i) it is preferred that at least one of the monomer repeat units present in the polymer has a stabilising group. Preferably, the stabilising groups can be reversibly converted from an ionic form to a non-ionic. As before, the groups are preferably such as to be converted by effecting a change in the pH of the dispersion. Preferred groups of this kind are carboxylic acid groups or salts thereof. Preferred polyesters and polyurethanes for the polymer particles have an acid value of from 1 to 75 mg KOH/g, more preferably from 5 to 50 mg KOH/g. Preferably, the acid groups are carboxylic acid groups or salts thereof.

### Preparation of the Non-Polymeric Particles

The non-polymeric particles in the dispersion may be prepared by a variety of suitable technologies. A preferred method is to disperse a non-polymeric material in a liquid medium using a dispersant. The dispersant is preferably as mentioned above in the section headed “Particle stabilisation”.

Preferred dispersion methods include stirring, tumbling and especially shaking optionally with milling beads. Specific suitable equipment includes a Dispermat™ mill, fitted either with a saw-tooth blade or adapted as a bead mill, or a Red Devil™ shaker (in which a dispersion of the non-polymeric material in water is shaken with beads). Shaking with milling media and/or stirring with a saw-toothed blade are particularly suitable methods.

Other suitable examples of dispersion methods include microfluidizing, high pressure homogenising and ultrasonication.

To target the required average particle size of 1 to 10 microns several preferred methods have been developed.

In one method the amount of dispersant relative to the non-polymeric particle is carefully controlled. Desirable results are achieved when the amount of dispersant is from 0.5 to 10, more preferably from 1 to 5 and especially from 1.5 to 3.0 parts by weight relative to 100 parts by weight of non-polymeric particles.

Other methods of controlling the particle size of the non-polymeric material include controlling the speed of the agitator (especially by using reduced speeds), the duration of the milling process (especially by using short milling times), the diameter of the milling beads (especially by using large milling beads), the concentration of the non-polymeric material in the dispersion and the ratio of non-polymeric material to beads.

### Amounts of Materials in the Dispersion Prior to Aggregation

Preferably, in step a) (prior to aggregation) the dispersion comprises:
i) 25 to 45 parts, more preferably 25 to 40 parts and especially 25 to 35 parts by weight of non-polymeric particles as defined in the first aspect of the present invention;
ii) 55 to 75 parts, more preferably 60 to 75 parts and especially 65 to 75 parts by weight of polymer particles as defined in the first aspect of the present invention.

Whilst it is possible that the dispersion in step a) (prior to aggregation) comprises minor amounts of optional particulate materials having a density of more than 4 g/cm³ these are preferably present at less than 10 parts by weight, more preferably less than 5 parts by weight, especially less than 1 part by weight and most especially the dispersion contains no such particles.

### Aggregation

The aggregation step may be effected by any suitable means. Preferred means include the addition of metal ion salts (e.g. calcium and aluminium salts), the addition of organic solvents, heating the dispersion, the addition of amines or polyamines, the addition of a counter charged dispersant or by a change in the pH of the dispersion.

Preferably, the aggregation is effected by a change in the pH of the dispersion. The change in the pH may be from acidic to basic but is preferably from basic to acidic. Preferably, the aggregation by a pH change is performed when the particles in the dispersion are stabilised by groups which can be converted from ionic to non-ionic form by the pH change.

Preferably, the pH change is at least 2 pH units, more preferably at least 4 pH units and most preferably at least 5 pH units. Preferably, the pH of the dispersion is initially 7 or more, more preferably 8 or more prior to a decrease in the pH of the dispersion.

In a preferred case the aggregation is effected by the addition of an acid and the pH of the dispersion is decreased. Suitable acids for this include the mineral acids such as nitric acid, phosphoric acid, hydrochloric acid and especially sulphuric acid. When acid induced aggregation is employed it is preferred that the particles in the dispersion are stabilised by carboxylic acid groups or salts thereof.

### Optional Growth

In some instances it is desirable to grow the average particle size of the aggregates prior to step b) stabilisation (when present) or step c) coalscence. This can be helpful in fine-tuning the average particle size of the aggregates and in narrowing the particle size distribution of aggregates.

The processes of the present invention preferably comprises a further growth step of heating and/or stirring (preferably both) the aggregate particles formed in step a). Preferably, the growth step is performed at a temperature of no more than the glass transition temperature (Tg)+10° C. of the polymer in the polymer particles. Preferably such heating and/or stirring of the aggregate particles causes loose (uncoalesced) aggregates to form and/or grow to the desired size. The growth step is preferably performed at a temperature not lower than about 25° C. below the Tg of the polymer in the polymer particles. The growth step is preferably performed at a temperature in a range which is from 25° C. below the Tg to no more than Tg+10° C., wherein the Tg refers to the glass transition temperature of the polymer in the polymer particles. In a preferred process the growth step is implemented between the between step a) and optional step b).

### Optional Stabilisation

Prior to the heating step c) it is often desirable to further stabilise the aggregates. This can be done by a number of different methods. One method is to add dispersants to the aggregated particles. The dispersants are as hereinbefore mentioned and preferred. Another method is to adjust the pH, preferably from pH 5 to 12, especially from 6 to 9. Another method is to add sulfo or phospho functional surfactants, for example sodium lauryl sulphate or sodium dodecyl benzene sulfonate. These methods alone or in any combination help to prevent the aggregates from further aggregating or from flocculating and precipitating at the higher temperatures used to coalesce the aggregates.

### Heating to Coalesce the Aggregates

The heating step c) causes the aggregated particles to coalesce. Preferably, the heating is performed at a temperature of from 40 to 120° C., more preferably from 60 to 120° C., especially from 80 to 120° C. Where temperatures of over 100° C. are employed it is often desirable to heat the aggregates at a pressure above atmospheric pressure. In some cases it is preferred that the heating step uses temperatures which do no exceed 100° C. A particularly preferred range is from 70 to 95° C.

Preferably, the time for the heating step is from 1 minute to 10 hours, especially from 10 minutes to 5 hours and more especially from 1 to 4 hours.

### Final Particles

Preferably, the final particulate solid has an average particle shape which is substantially spherical or spheroidal. The average circularity of the particulate solid is preferably at least 0.90, more preferably at least 0.92, even more preferably at least 0.93 and especially at least 0.94. Of course, the highest average circularity value possible is exactly 1.0. The average circularity of the particulate solid is preferably less than 0.99, more preferably less than 0.98. A particularly preferred range is from 0.90 to 1.0, more preferably from 0.92 to 0.99, especially from 0.92 to 0.98 and most especially from 0.94 to 0.98.

We have found that preparing final particles having these preferred circularities is extremely difficult with the processes previously known in the art. We have found that obtaining these circularities is especially difficult when the amounts of non-polymeric particles is relatively high, especially in the region of 25 to 50 parts by weight. Whilst not wishing to be limited by any particular theory it is believed that larger amounts of non-polymeric particles impairs the coalescence and flow of the polymer particles in the heating step c).

Preferably, the average circularity is measured by a Flow Particle Image Analyser. A preferred example of which is a Sysmex FPIA-3000 device sold by Malvern. Preferably, the average circularity is a number average. Preferably, the shapes of at least 1,000 and more preferably at least 5,000 particles are determined and averaged so as to provide the average circularity value.

The average particle size of the final particulate solid is preferably measured using electrozone sensing. A suitable apparatus is the Coulter Counter. A specifically preferred apparatus is a Coulter Multisizer™ 3 from Beckman Coulter.

### Formulation

The final particulate solid may be used to prepare toners for electrophotography. For this application it is often desirable to add external additives to improve flow and/or charging properties.

Examples of suitable external additives include silicon dioxide, titanium dioxide, aluminium oxide, zinc state and the like.

Often these external additives are hydrophobized.

Generally speaking such external additives are mechanically blended with the particulate solid at from 0.1 to 5%, especially from 0.5 to 3% by weight relative to the weight of the particulate solid.

### Second Aspect

According to a second aspect of the present invention there is provided a particulate solid obtained or obtainable by the process according to the first aspect of the present invention.

### EXAMPLES

The present invention will now be illustrated by the following examples in which all parts are by weight unless stated to the contrary. The actual experiments were performed wherein the parts are g (grams).

### 1. Polymer Dispersions

### 1.1. Polymer Dispersion 1

A dispersion of polymer particles was synthesised by emulsion polymerisation. The monomers used were: styrene (74.9 parts), 2-hydroxyethyl methacrylate (2.5 parts) and (meth)acrylic ester monomers (22.6 parts) (consisting of 18.4 parts butyl acrylate and 4.2 parts methyl methacrylate).

Ammonium persulphate (0.5 wt % based on the total weight of the monomers) was used as the initiator, and a mixture of thiol chain transfer agents (2.5 wt % based on the total weight of the monomers) was used to provide a polymer having a low molecular weight. The dispersant (3 wt % based on the total weight of the monomers) was Akypo™ RLM100 (available from Kao), a carboxylated alkyl ethoxylate, i.e. a carboxy-functional anionic dispersant. The dispersion of polymer particles produced had a dv50 average particle size of 107 nm as measured with a Malvern Mastersizer™ 2000. A sample of the dispersion was dried down for Differential Scanning calorimetry (DSC) and Gel Permeation Chromatography (GPC) analysis. The glass transition temperature (Tg) as measured by DSC was 51° C. GPC analysis against polystyrene standards showed the resin of the latex to have a number averaged molecular weight (Mn)=9,200, a weight averaged molecular weight (Mw)=22,700 and a polydispersity (Mw/Mn)=2.5. The solids content of the polymer particles in the dispersion was 30 wt %. This was designated Polymer Dispersion 1. The resin in Polymer Dispersion 1 contained high proportions of the styrene repeat unit.

### 1.2 Polymer Dispersion 2

A dispersion of polymer particles was synthesised by emulsion polymerisation in a similar manner to Polymer Dispersion 1, except that the monomers used were: methyl methacrylate (76.0 parts), butyl acrylate (21.5 parts) and 2-hydroxyethyl methacrylate (2.5 parts) and 5.0% of a mixture of thiol chain transfer agents was used. The dispersion of polymer particles produced had a dv50 average particle size of 110 nm as measured with a Malvern Mastersizer™ 2000. A sample of the dispersion was dried down for Differential Scanning calorimetry (DSC) and Gel Permeation Chromatography (GPC) analysis. The glass transition temperature (Tg) as measured by DSC was 40° C. GPC analysis against polystyrene standards showed the resin of the latex to have a number averaged molecular weight (Mn)=4,000, a weight averaged molecular weight (Mw)=12,700 and a polydispersity (Mw/Mn)=3.2. The solids content of the polymer particles in the dispersion was 29.5 wt %. This was designated Polymer Dispersion 2. The resin in Polymer Dispersion 2 contained high proportions of the methyl methacrylate repeat unit.

### 1.3 Polymer Dispersion 3

A dispersion of polyester particles was prepared. The dispersion of polymer particles had a dv50 average particle size of 128 nm as measured with a Malvern Mastersizer™ 2000. A sample of the dispersion was dried down for Differential Scanning calorimetry (DSC) and Gel Permeation Chromatography (GPC) analysis. The glass transition temperature (Tg) as measured by DSC was 63° C. GPC analysis against polystyrene standards showed the resin of the latex to have a number averaged molecular weight (Mn)=3,200, a weight averaged molecular weight (Mw)=18,300 and a polydispersity (Mw/Mn)=5.7. The acid value of the polyester was 16 mg KOH/g. The solids content of the polymer particles in the dispersion was 29.7 wt %. This was designated Polymer Dispersion 3. The resin in Polymer Dispersion 3 was a polyester polymer.

### 2. Pigment Dispersion (Dispersion of Non-Polymeric Particles)

### 2.1. Pigment Dispersion 1

C.I. Pigment Blue 15:3 (Sigma Aldrich) was used as a pigment. This pigment has a density of about 1.6 g/cm³. The pigment (100 parts) was milled in water for 11 hrs using 3 mm glass beads with a Red Devil disperser along with Akypo™ RLM100 (2 parts of active dispersant). The total solids content of the dispersion, including the dispersant, was 23.7 wt %. The dispersion had a dv50 particle size of 3.8 μm as measured with a Malvern Mastersizer™ 2000. This was designated Pigment Dispersion 1. It had an average particle size which was as required by the present invention.

### 2.2 Pigment Dispersion 2

A dispersion of C.I Pigment Blue 15.3 was made in the same way as Pigment Dispersion 1. The total solids content of the dispersion, including the dispersant, was 24.8 wt %. The dispersion had a dv50 particle size of 3.8 μm as measured with a Malvern Mastersizer™ 2000. This was designated Pigment Dispersion 2. It had an average particle size which was as required by the present invention.

### 2.3 Pigment Dispersion 3

C.I. Pigment Blue 15:3 (Tokyo Chemical Industry UK Ltd) was used as a pigment. This pigment has a density of about 1.6 g/cm³. The pigment (100 parts) was milled in water for 16 hrs using 3 mm glass beads with a Red Devil disperser along with Akypo™ RLM100 (2 parts of active dispersant). The total solids content of the dispersion, including the dispersant, was 21.7 wt %. The dispersion had a dv50 particle size of 2.7 μm as measured with a Malvern Mastersizer™ 2000. This was designated Pigment Dispersion 3. It had an average particle size which was as required by the present invention.

### 2.4. Pigment Dispersion C1 (Comparative Pigment Dispersion)

A dispersion of C.I. Pigment Blue 15:3 was obtained. This pigment has a density of about 1.6 g/cm³. The pigment (100 parts) had previously been milled in water with a bead mill along with Akypo™ RLM100 (10 parts of active dispersant) and Solsperse™ 27000 (10 parts). Solsperse™ 27000 is a non-ionic dispersant available from Noveon. The total solids content of the dispersion, including the dispersants was 30.23 wt %. The dispersion had a dv50 particle size of 0.103 μm as measured with a Malvern Mastersizer™ 2000. This was designated Pigment Dispersion C1, it had an average particle size which was outside the requirements of the present invention and which was representative of the size of pigment dispersions previously used in the art of toner preparation.

### 3. Synthesis of Pigmented Polymer Particles by Aggregation Using an Acrylic Polymer

### 3.1 Example 1

### Preparation of Particulate Solid 1

### 3.1.1 Preparation of Mixed Dispersion 1

Polymer Dispersion 1 (150 parts) as prepared in step 1.1 above, and Pigment Dispersion 1 as prepared in step 2.1 above (64.6 parts, containing 15.0 parts of C.I. Pigment Blue 15:3) and water (226 parts) were stirred in a vessel to provide Mixed Dispersion 1.

### 3.1.2 Aggregation (Step a)

The temperature of Mixed Dispersion 1 was raised to 30° C. Over the course of 165 seconds Mixed Dispersion 1 was circulated through a high shear mixer and back into the vessel during which time 0.5N sulphuric acid (60.0 parts) was added into the high shear mixer to cause aggregation of the particles. After acid addition the pH of the liquid medium was 1.74. This formed aggregated particles (or clusters of particles).

### 3.1.3 Growth

The particle aggregates formed in step 3.1.2 were heated for the next 177 minutes (experiencing a maximum temperature of 50.5° C.) to grow the aggregates. The aggregated particles were then cooled to 41° C.

### 3.1.4 Stabilisation (Step b)

A solution of sodium hydroxide 0.5 M (50 parts) was added to the aggregated particles over 10 minutes to raise the pH to 7. A solution of sodium dodecylbenzenesulphonate (10 wt %, 15.0 parts) as a surfactant was then added over 6 minutes. The pH was maintained at 7 after sodium dodecylbenzenesulphonate addition by the addition of further sodium hydroxide solution. This had the effect of colloidally stabilising the aggregates and preventing further particle size growth.

### 3.1.5 Coalescence of Aggregates (Step c)

The temperature of the stabilised aggregated particles formed in step 3.1.4 was then raised to induce coalescence. The time taken to heat the particles from 40° C. to 90° C. was 23 minutes. Heating at 90° C. was continued for 180 minutes. Samples were withdrawn periodically to measure the circularity of the particles using a Sysmex™ FPIA-3000 device sold by Malvern. At the end of the heating process the temperature was reduced to room temperature (25° C.) over approximately 15 minutes.

Coulter Multisizer™ 3 analysis of particles above 2 μm in size showed the median volume particle size was 9.2 μm in diameter. Observation using an optical microscope showed the resulting final particulate solid to be off-spherical, but with a relatively smooth shape (potato shaped). The particles appeared to be well coalesced. This was designated as Particulate Solid 1. Particulate Solid 1 contained 25 parts by weight of non-polymeric material (Pigment) to 75 parts by weight of polymer material.

### 3.2 Comparative Example 1

### Preparation of Particulate Solid C1

3.2.1 Particulate Solid C1 (comparative)

Particulate Solid C1 (a comparative) was made in exactly the same way as Particulate Solids 1, except that Pigment Dispersion C1 was used in place of Pigment Dispersion 1. Samples were taken periodically during the coalescence step c) to measure the circularity of the particles using a Sysmex™ FPIA-3000 device sold by Malvern.

Coulter Multisizer™ 3 analysis of resulting particles above 2 μm in size showed the median volume particle size was 7.4 μm in diameter. Observation using an optical microscope showed the resulting final particulate solid to be irregular in shape, and markedly less well coalesced than Particulate Solid 1. This was designated as Particulate Solid C1. Particulate Solid C1 contained 25 parts by weight of non-polymeric material (Pigment) to 75 parts by weight of polymer material.

### 4. Summary of Examples

TABLE 1

| Particulate | Example | Pigment | Particle size of |
|---|---|---|---|
| Solids | Type | Dispersion | pigment dispersion |
| 1 | Inventive | 1 | 3.8 μm |
| C1 | Comparative | C1 | 0.103 μm |

As can be seen Particulate solid 1 and comparative Particulate solid C1 differ in the particle size of the pigment dispersion.

### 5. Results

TABLE 2

Average Circularity (2-100 μm)

| Time at 90° C. | Particulate | Particulate |
|---|---|---|
| (mins) | Solid 1 | Solid C1 |
| 0 | 0.904 | |
| 3 | | 0.905 |
| 24 | | 0.909 |
| 30 | 0.915 | |
| 43 | | 0.912 |
| 75 | 0.924 | |
| 76 | | 0.913 |
| 105 | 0.930 | |
| 113 | | 0.913 |
| 135 | 0.932 | |
| 136 | | 0.917 |
| 163 | | 0.917 |
| 165 | 0.936 | |
| 180 | 0.939 | |

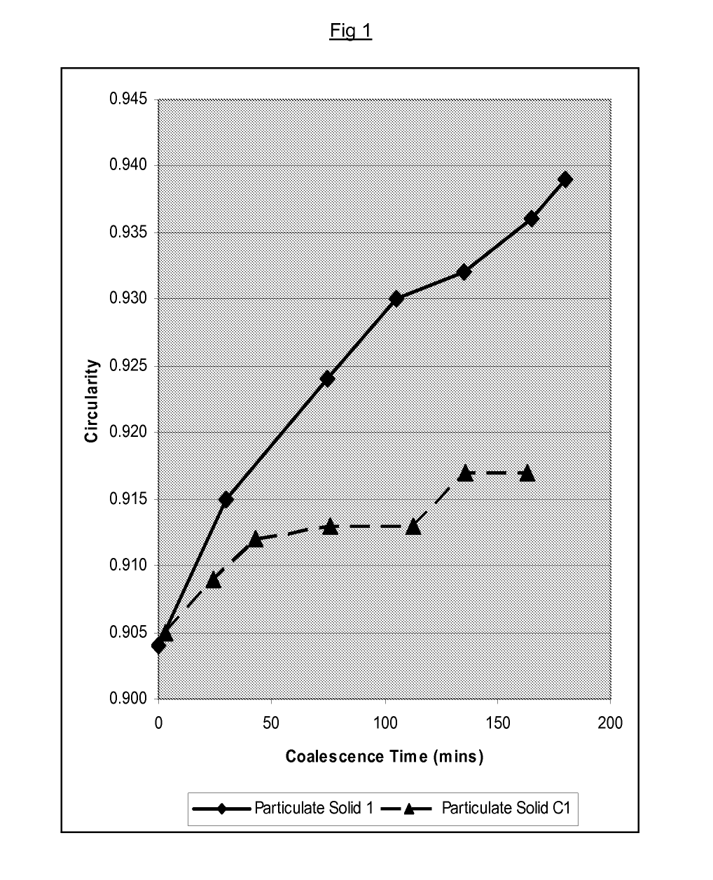

These results are also shown in graphical form in FIG. 1. From both Table 2 and FIG. 1 it can readily be seen that the present invention provides particles which coalesce markedly quicker and more effectively than those previously known in the art. This means that higher proportions of pigment can be effectively incorporated whilst still achieving the desired coalescence and particle circularity. As can be seen the comparative toner fails to provide a circularity of 0.92 even after long fusion times.

### 6. Further Acrylic Examples

Particulate Solid 2 and Particulate Solid C2 were made in a similar manner to Particulate Solid 1 and C1, except that the polymer dispersions, pigment dispersions, pigment levels and coalescence conditions were as outlined in Table 3.

TABLE 3

Particulate Solid

| | 2 | C2 |
|---|---|---|
| Example Type | Inventive | Comparative |
| Polymer Dispersion | 2 | 2 |
| Pigment Dispersion | 2 | C1 |
| Particle Size of Pigment | 3.8 | 0.103 |
| Dispersion (μm) | | |
| Pigment Level (wt %) | 30 | 30 |
| Coalescence Temperature (° C.) | 80 | 80 |
| Dv50 (μm) | 9.3 | 8.5 |

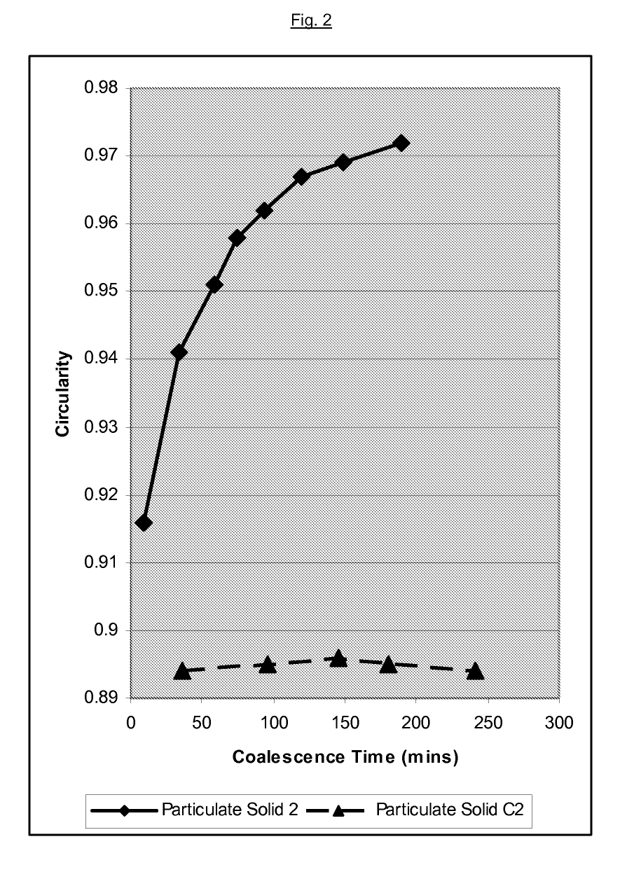

The circularity data for Particulate Solid 2 and Particulate Solid C2 as a function of coalescence time are shown in Table 4 and graphically in FIG. 2.

### 7. Results

TABLE 4

Average Circularity (2-100 μm)

| Time at 80° C. | Particulate | Particulate |
|---|---|---|
| (mins) | Solid 2 | Solid C2 |
| 9 | 0.916 | |
| 34 | 0.941 | |
| 36 | | 0.894 |
| 59 | 0.951 | |
| 74 | 0.958 | |
| 94 | 0.962 | |
| 96 | | 0.895 |
| 119 | 0.967 | |
| 146 | | 0.896 |
| 149 | 0.969 | |
| 181 | | 0.895 |
| 189 | 0.972 | |
| 241 | | 0.894 |

From both Table 4 and FIG. 2 it can readily be seen that the present invention provides particles which coalesce markedly quicker and more effectively than those previously known in the art. This means that higher proportions of pigment can be effectively incorporated whilst still achieving the desired coalescence and particle circularity. As can be seen the comparative toner fails to provide a circularity of 0.90 even after long fusion times. It can also be seen that Particulate Solid 2 coalesces more readily than Particulate Solid 1 even though the coalescence temperature used for Particulate Solid 2 was 10° C. lower than that used for Particulate Solid 1. The improved coalescence rates for Particulate Solid 2 are considered to be attributable, in part, to the presence of methyl methacrylate repeat units in the polymer particles.

### 8. Polyester Examples

### 8.1 Particulate Solid 3

### 8.1.1 Preparation of Mixed Dispersion 2

Polymer Dispersion 3 (354 parts) and Pigment Dispersion 3 as prepared in step 2.3 above (212 parts, containing 45.0 parts of C.I. Pigment Blue 15:3) and water (835 parts) were stirred in a vessel to provide Mixed Dispersion 2.

### 8.1.2 Aggregation (Step a)

The temperature of Mixed Dispersion 2 was raised to 30° C. Over the course of 250 seconds Mixed Dispersion 2 was circulated through a high shear mixer and back into the vessel during which time 0.5N sulphuric acid (100 parts) was added into the high shear mixer to cause aggregation of the particles. After acid addition the pH of the liquid medium was 2.0. This formed aggregated particles (or clusters of particles).

### 8.1.3 Growth

The particle aggregates formed in step 8.1.2 were heated for the next 55 minutes (experiencing a maximum temperature of 48° C.) to grow the aggregates. The particle size was measured at this point and the median volume particle size was 6.5 μm.

### 8.1.4 Stabilisation (Step b)

A solution of sodium dodecylbenzenesulphonate (10 wt %, 37.5 parts) as a surfactant was added to the aggregated particles over 10 minutes. A solution of sodium hydroxide 0.5 M (118 parts) was then added over 5 minutes to raise the pH to 8.7. This had the effect of colloidally stabilising the aggregates and preventing further particle size growth.

### 8.1.5 Coalescence of Aggregates (Step c)

The temperature of the stabilised aggregated particles formed in step 8.1.4 was then raised to induce coalescence. The temperature was raised to 64° C. over 30 minutes, and the pH adjusted to 8.5 by the addition of a few drops of 0.5M sodium hydroxide solution. The temperature was then increased to 90° C. over 50 minutes, and then maintained at 90° C. for a further 250 minutes. Samples were withdrawn periodically to measure the circularity of the particles using a Sysmex™ FPIA-3000 device sold by Malvern. At the end of the heating process the temperature was reduced to room temperature (25° C.) over approximately 15 minutes.

Coulter Multisizer™ 3 analysis of particles above 2 μm in size showed the median volume particle size was 7.0 μm in diameter. Observation using an optical microscope showed the resulting final particulate solid to be nearly spherical. The particles appeared to be well coalesced. This was designated as Particulate Solid 3. Particulate Solid 3 contained 30 parts by weight of non-polymeric material (Pigment) to 70 parts by weight of polymer material. The polymer material was a polyester.

### 8.2 Particulate Solid C3

Particulate Solid C3 was made in a similar manner to Particulate Solid 3, except that Pigment Dispersion C1 was used in place of Pigment Dispersion 3. The median volume particle size just before the addition of sodium dodecylbenzenesulphonate solution was 5.4 μm. During the coalescence step there was a large increase in particle size, such that the final measured median volume particle size was 12.3 μm. In addition the aggregates produced were of irregular shape.

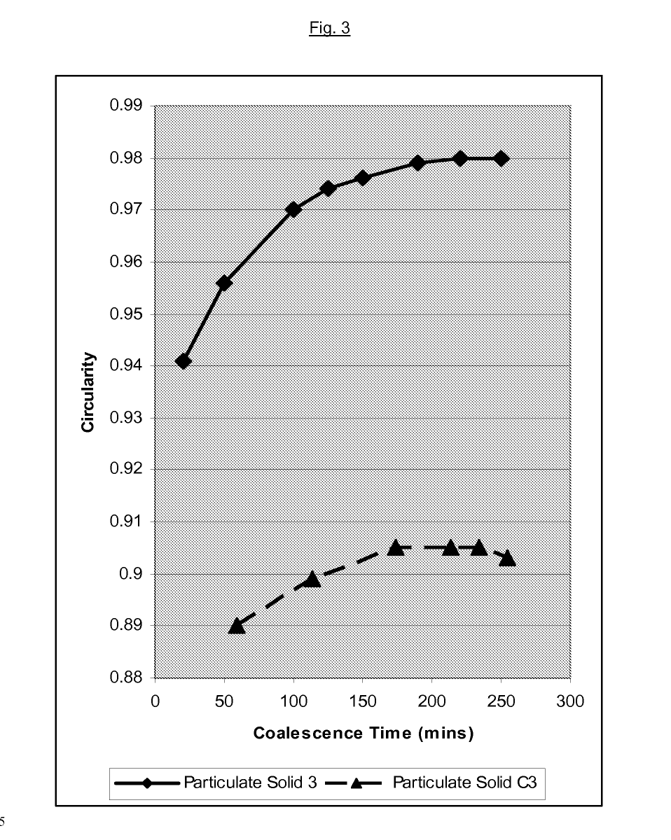

The circularity data for Particulate Solid 3 and Particulate Solid C3 as a function of coalescence time are shown in Table 5 and graphically in FIG. 3.

TABLE 5

Average Circularity (2-100 μm)

| Time at 90° C. | Particulate | Particulate |
|---|---|---|
| (mins) | Solid 3 | Solid C3 |
| 20 | 0.941 | |
| 50 | 0.956 | |
| 59 | | 0.890 |
| 100 | 0.970 | |
| 114 | | 0.899 |
| 125 | 0.974 | |
| 150 | 0.976 | |
| 174 | | 0.905 |
| 190 | 0.979 | |
| 214 | | 0.905 |
| 220 | 0.980 | |
| 234 | | 0.905 |
| 250 | 0.980 | |
| 254 | | 0.903 |

From both Table 5 and FIG. 3 it can readily be seen that the present invention provides particles which coalesce markedly quicker and more effectively than those previously known in the art. This means that higher proportions of pigment can be effectively incorporated whilst still achieving the desired coalescence and particle circularity. As can be seen the comparative toner only reaches a circularity of 0.90-0.91 even after long fusion times. In addition the comparative toner is much less stable in that it shows considerable particle size growth during the coalescence step.

### 8.3 Particulate Solid 4

### 8.3.1 Preparation of Mixed Dispersion 3

Polymer Dispersion 3 (248 parts) and Pigment Dispersion 3 as prepared in step 2.3 above (148 parts, containing 31.5 parts of C.I. Pigment Blue 15:3) and water (1034 parts) were stirred in a vessel to provide Mixed Dispersion 3.

### 8.3.2 Aggregation (Step a)

The temperature of Mixed Dispersion 3 was raised to 30° C. Over the course of 250 seconds Mixed Dispersion 3 was circulated through a high shear mixer and back into the vessel during which time 0.5N sulphuric acid (70 parts) was added into the high shear mixer to cause aggregation of the particles. After acid addition the pH of the liquid medium was 2.1. This formed aggregated particles (or clusters of particles).

### 8.3.3 Growth

The particle aggregates formed in step 8.3.2 were heated for the next 90 minutes (experiencing a maximum temperature of 51° C.) to grow the aggregates. The particle size was measured at this point and the median volume particle size was 10.2 μm.

### 8.3.4 Stabilisation (Step b)

A solution of sodium dodecylbenzenesulphonate (10 wt %, 26.3 parts) as a surfactant was added to the aggregated particles over 5 minutes. A solution of sodium hydroxide 0.5 M (95 parts) was then added over 15 minutes to raise the pH to 8.7. This had the effect of colloidally stabilising the aggregates and preventing further particle size growth.

### 8.3.5 Coalescence of Aggregates (Step c)

The temperature of the stabilised aggregated particles formed in step 8.3.4 was then raised to induce coalescence. The temperature was raised to 64° C. over 45 minutes, and the pH adjusted to 8.5 by the addition of a few drops of 0.5M sodium hydroxide solution. The temperature was then increased to 90° C. over 40 minutes, and then maintained at 90° C. for a further 250 minutes. Samples were withdrawn periodically to measure the circularity of the particles using a Sysmex™ FPIA-3000 device sold by Malvern. At the end of the heating process the temperature was reduced to room temperature (25° C.) over approximately 15 minutes.

Coulter Multisizer™ 3 analysis of particles above 2 μm in size showed the median volume particle size was 11.1 μm in diameter. Observation using an optical microscope showed the resulting final particulate solid to be nearly spherical. The particles appeared to be well coalesced. This was designated as Particulate Solid 4. Particulate Solid 4 contained 30 parts by weight of non-polymeric material (Pigment) to 70 parts by weight of polymer material.

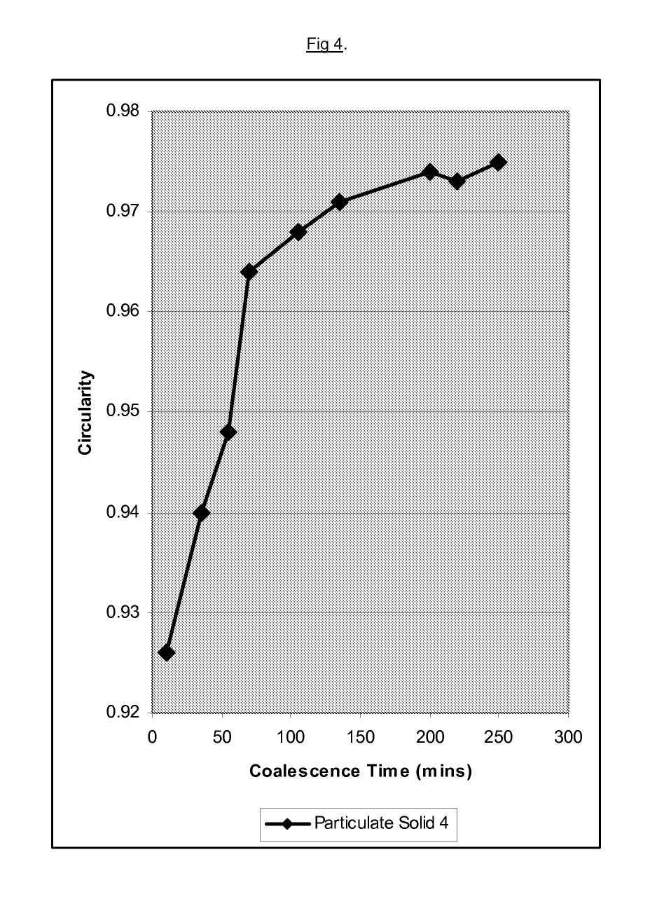

The circularity data for Particulate Solid 4 as a function of coalescence time are shown in Table 6 and graphically in FIG. 4.

TABLE 6

| Time at 90° C. | Average Circularity (2-100 μm) |
|---|---|
| (mins) | Particulate Solid 4 |
| 10 | 0.926 |
| 35 | 0.940 |
| 55 | 0.948 |
| 70 | 0.964 |
| 105 | 0.968 |
| 135 | 0.971 |
| 200 | 0.974 |
| 220 | 0.973 |
| 250 | 0.975 |

### 8.4 Particle Solid C4

### 8.4.1 Preparation of Mixed Dispersion 4

Polymer Dispersion 3 (354 parts) and Pigment Dispersion C1 as prepared in step 2.4 above (182 parts, containing 45 parts of C.I. Pigment Blue 15:3) and water (864 parts) were stirred in a vessel to provide Mixed Dispersion 4.

### 8.4.2 Aggregation (Step a)

The temperature of Mixed Dispersion 4 was raised to 30° C. Over the course of 200 seconds Mixed Dispersion 4 was circulated through a high shear mixer and back into the vessel during which time 0.5N sulphuric acid (100 parts) was added into the high shear mixer to cause aggregation of the particles. After acid addition the pH of the liquid medium was 2.3. This formed aggregated particles (or clusters of particles).

### 8.4.3 Growth

The particle aggregates formed in step 8.4.2 were heated for the next 200 minutes (experiencing a maximum temperature of 54° C.) to grow the aggregates. The particle size was measured at this point and the median volume particle size was 10.9 μm.

### 8.4.4 Stabilisation (Step b)

A solution of sodium dodecylbenzenesulphonate (10 wt %, 37.5 parts) as a surfactant was added to the aggregated particles over 10 minutes. A solution of sodium hydroxide 0.5 M (130 parts was then added over 10 minutes to raise the pH to 8.7. This had the effect of colloidally stabilising the aggregates and preventing further particle size growth.

### 8.4.5 Coalescence of Aggregates (Step c)

The temperature of the stabilised aggregated particles formed in step 8.4.4 was then raised to induce coalescence. The temperature was raised to 62° C. over 30 minutes, and then held at 62-65° C. for a further 30 minutes. The temperature was then increased to 90° C. over 50 minutes. On reaching 90° C. the circularity of the particles was measured using a Sysmex™ FPIA-3000 device sold by Malvern and found to be 0.832. Coulter Multisizer™ 3 analysis of particles above 2 μm in size showed the median volume particle size was 20 μm in diameter. After a further 10 minutes heating at 90° the preparation was stopped due to a high level of grit forming in the vessel, and the temperature was reduced to room temperature (25° C.) over approximately 30 minutes.

This was designated as Particulate Solid C4. Particulate Solid C4 contained 30 parts by weight of non-polymeric material (Pigment) to 70 parts by weight of polymer material.

1. A process for preparing a particulate solid comprising the steps:
a) aggregating a dispersion comprising the particles i), ii) and a liquid medium:
i) 25 to 50 parts by weight of non-polymeric particles having an average particle size of from 1 to 10 microns and having a density of no more than 4 g/cm³;
ii) 50 to 75 parts by weight of polymer particles having an average particle size of from 50 to 150 nm;
b) optionally stabilising the aggregated particles;
c) heating the aggregated particles so as to cause particle coalescence.

2. A process according to claim 1 wherein the non-polymeric particles have an average particle size of from 1 to 5 microns.

3. A process according to claim 1 wherein the non-polymeric particles have a density of no more than 2 g/cm³.

4. A process according to claim 1 wherein the non-polymeric particles are stabilised by a dispersant which is present at from 1 to 5 parts by weight relative to 100 parts by weight of the non-polymeric particles.

5. A process according to claim 1 wherein the non-polymeric particles have been prepared by shaking with milling media and/or stirring with a saw-toothed blade.

6. A process according to claim 1 wherein the aggregation is effected by a change in the pH of the dispersion.

7. A process according to claim 1 wherein the non-polymeric particles are selected from pigments and charge control agents.

8. A process according to claim 1 wherein the polymer particles have an average particle size of from 90 to 140 nm.

9. A process according to claim 1 wherein the non-polymeric particles have an average particle size of from 2 to 5 microns.

10. A process according to claim 1 wherein the polymer material in the polymer particles is selected from polyesters, polycarbonates, polyurethanes, waxes and polymers prepared by the polymerisation of ethylenically unsaturated monomers

11. A process according to claim 1 wherein the polymer particles comprise less than 10% by weight of wax.

12. A process according to claim 1 wherein the polymer and the non-polymeric particles are stabilised by groups which are reversibly convertible from an ionic to a non-ionic form by means of adjusting the pH.

13. A process according to claim 1 wherein the final coalesced particulate solid has an average circularity of from 0.90 to 1.0.

14. A process according to claim 13 wherein the final coalesced particulate solid has an average circularity of from 0.92 to 0.98.

15. A process according to claim 1 wherein the heating in step c) is performed at a temperature of from 70 to 95° C. for a period of 1 to 4 hours.

16. A process according to claim 1 wherein the polymer in the polymer particles comprises at least 40 wt % of repeat units from methyl methacrylate.

17. A particulate solid obtained or obtainable by the process of claim 1.
